(19) United States
(12) Patent Application Publication
(10) Pub. No.: US 2023/0311581 A1
(43) Pub. Date: Oct. 5, 2023

(54) TIRE WEAR PREDICTION

(71) Applicant: Enervibe Ltd., Airport City (IL)

(72) Inventor: Dan Haronian, Efrat (IL)

(73) Assignee: Enervibe Ltd., Airport City (IL)

(21) Appl. No.: 17/734,069

(22) Filed: May 1, 2022

Related U.S. Application Data
(63) Continuation-in-part of application No. 17/709,430, filed on Mar. 31, 2022, now abandoned.

(51) Int. Cl. B60C 11/24; B60C 19/00

(52) U.S. Cl. CPC B60C 11/246; B60C 2019/004; B60C 19/00

(57) ABSTRACT

A system for a tire mounted on a wheel of a vehicle that includes a chassis, a light source, a light sensor, a transmission unit, and a processing unit. The chassis is attached to the inner side of the tire, and the light source and the light sensor are attached to the chassis so that when the light source illuminates, a returning light is be detected by the light sensor, that produces a signal based on changes in intensity of the detected light. The changes reflect frequencies and amplitudes of the tire vibrations or tire bends of the tire part that crosses the contact patch. The processing unit detects characteristics of the contact area, the type of the road, the degree of the tire wear, or the size of load on the wheel based on the signal.

### RELATED APPLICATIONS

This application is a continuation in part of U.S. patent application Ser. No. 17/709,430 filed on Mar. 31, 2022.

### TECHNICAL FIELD

This patent application refers to a method for estimating tire properties such as characteristics of tire contact patch with the ground, tire wear-out, load on a tire and road roughness, using an in-tire sensor for measuring tire vibrations and. The patent also refers to sensing of tire modes using means such as optical sensing and electromagnetic sensing.

### BACKGROUND OF THE INVENTION AND PRIOR ART

Vehicles are going through major revolutions. From powering by fuel to powering by electricity, from human control to machine control. In the coming years more and more autonomous and electrical vehicles will occupy the roads with increasing efficacy and sophistication. On the other hand, and despite a gradual material improvement, tires remain more or less the same. Tire Pressure Monitoring System (TPMS) is the only available in-tire sensor mainly because a tire is a close environment and disposable battery is the only way to power an in-tire sensor. In practice the lifetime of the battery controls the amount of power it may use on average, to support the TPMS. An increase in the average power consumption may result in higher rate of data transmission, or more in-tire sensors, but this will lead to short battery lifetime to a point where rapid battery replacement is required which makes such a concept impractical.

Tires are the interface of a vehicle with the road. Although they typically wear out gradually, sometimes they abruptly explode as a result of tire anomalies or a pit hole on the road that causes a fatal defect that leads to fast tire depletion or even explosion. The tire may roll on smooth or rough pavements, on wet, snowed, or icy road, each with different braking time, that if known would have greatly benefited vehicle ADAS. Tire load is also an important property. Not only for trucks where load transmission once every 10 min as required by EU regulation, but also for adjusting the ADAS parameters during braking or cornering. In addition, offering weight measurements of a vehicle provides electrical vehicle real-time estimation of the remaining time before recharging is required. In addition, tire condition affects vehicle fuel consumption and downtime of vehicles of fleets such as trucks and rentable vehicles which affects the fleets profitability,

Smart tires could have played a critical role in vehicle real-time control and maintenance if a sufficient power source could have been integrated to support in-tire sensors. One way to overcome this problem is by estimating the properties described above through sensors on the vehicle chassis. Yet, such estimation cannot be as accurate and as fast as measuring the tire and road properties directly from the tire behavior.

FIG. 1A refers to patent application U.S. Pat. No. 9,050,864B2 describing the first radial mode of a tire at different tire tread depth showing that the peak and frequency of the vibration changes with the tread depth. This patent claims tire wear estimation means for estimating tire wear state based upon the tire inflation pressure data, the vertical mode frequency data, and the tire-specific frequency mode coefficients.

Patent publication number U.S. Pat. No. 9,290,069A tire inner liner-based system for estimating a vehicle parameter comprising: at least one tire supporting a vehicle, the tire having tire sidewalk and a tire crown Supporting a tire inner liner defining a tire air cavity; at least one tire pressure sensor mounted to the one tire for detecting a measured tire air cavity pressure; at least one vehicle speed sensor mounted to provide a measured vehicle speed; at least one tire identification device mounted to the tire for providing a tire identification; at least one tire inner liner deflection sensor mounted to provide a loaded inner liner radius measurement; estimating means for calculating a vehicle parameter estimation estimated tire parameter from the measured tire air cavity pressure and the loaded inner liner radius measurement; and wherein the at least one tire inner liner deflection sensor is a sensor taken from the sensor group laser distance sensor, eddy current sensor, magneto-inductive sensor, capacitive sensor.

FIG. 1B describes the laser distance sensor (2001) that is fixed to the rim on which the tire is mounted on and measures the distance between the rim and the tire. The distance between the rim and the tire as measured by the laser distance sensor together with the pressure of the tire cavity are used to calculate the load on the tire.

Typically, the distance between the rim and the inner side of the tire is in the order of 30 cm in a passenger tire and can go up to 70 cm in a truck tire. A regular light source such as light emitting diode that (LED) fixed to the rim and oriented to the tire will result in large light dispersion that will be reflected back to the light sensor from a wide area of the tire that will lead to a poor patch length estimation. For a proper optical measurement of the patch length a focused light source or a laser diode are required in order to limit the reflection of the light from a narrow enough area on the inner side of the tire. Indeed, patent publication number U.S. Pat. No. 9,290,069A uses a laser distance sensor which is an expensive light source. In addition, for an in-tire optical sensor to be practical it cannot be powered by a battery that will be drained in relatively short time and therefore is not practical. Such a sensor must be supported by an energy harvester such as a kinetic energy harvester that converts the tire bends or vibrations into electricity. Fixing an optical sensor on the rim and a kinetic energy harvester on the tire results in a complex method or system.

In addition, a fire sensor that uses an accelerometer is a known art. The accelerometer is mounted on the inner side of a tire such that when the wheel rotates the accelerometer senses the change in acceleration as it enters and exits the contact patch. Such measuring of contact patch length allows the estimate of the load on the tire. Accelerometer has relatively large Signal to Noise ratio (SNR) due to high Brownian noise. This noise will limit the accuracy of the contact patch length measurement and will therefore limit the load estimation accuracy.

Patent publication number JP4165320B2, describes a tire condition detection device that uses strain gauges (2003, 2004) embedded inside the tire as described in FIG. 1C. Patent publication number EP2085253B1 describes a tire with a sensor and methods for measuring tire strain using strain gauges fixed to the inner side of the tire.

The disadvantage of using a strain gauge and accelerometers is the fact that these sensors are strained directly or indirectly. A strain gauge fixed to the tire or embedded inside the tire goes through compressive and tensile straining that are the source of an electrical signal generated by the strain gauge in response to the bends of the tire. An accelerometer uses a seismic mass suspended by a spring that responds to acceleration and deceleration during tire rotation that cause the seismic mass to vibrate and to the spring to go through compressive and tensile stresses. The accelerometer may also be subject to high accelerations that may cause the springs to bend beyond their elastic range. The lifetime of these devices is limited by the number of cycles they can withstand and are limited by a maximum allowed force.

### BRIEF DESCRIPTION OF THE FIGURES

FIG. 1A: A schematic depiction of prior art showing the first radial vibration mode of a tire at different tire wear-out.

FIG. 1B: A schematic depiction of prior art showing an optical distance sensor (2001) mounted on a rim of a tire for measuring tire bending.

FIG. 1C: A schematic depiction of prior art showing two strain sensors (2002) and (2003) fixed to the inside of a tire for measuring tire bending.

FIG. 2A: A schematic depiction of tire (1001) on a rim (1002) rolling over the ground (1003).

FIG. 2B: A schematic depiction of signals generated by a tire bending sensor as it crosses the patch area (10041) described in FIG. 2A.

FIGS. 3A and 3B: A schematic depiction of a tire model.

FIG. 3C: A schematic depiction of a tire using the model described in FIG. 3A.

FIG. 4: A schematic depiction of a tire's radial vibrational modes.

FIG. 5: A schematic depiction of a tire's lateral vibrational modes.

FIG. 6: A schematic depiction of a tire's transversal vibrational modes.

FIGS. 7A and 7B: Schematic depictions of a tire with uniform (72) wear-out.

FIGS. 8A and 8B: Schematic depictions of a tire with toe (74) wear-out.

FIGS. 9A and 9B: Schematic depictions of a tire with edge (671), (672) wear-out.

FIGS. 10A and 10B: Schematic depictions of a tire with center (78) wear-out.

FIGS. 11A and 11B: Schematic depictions of a tire with radial (80) wear-out.

FIG. 12: Schematic depiction of tire with patch (83) wear-out.

FIG. 13: A schematic depiction of a module (100) for measuring tire and road properties.

FIG. 14: A schematic depiction of module (100) fixed to the inner side (36) of the tire (30) of vehicle (1000) for measuring tire and road properties.

FIG. 15: A schematic depiction of a power source (101) that is a kinetic energy harvester (1010) with power management (1012) and a battery (1011) that may be a rechargeable or a non-rechargeable battery.

FIG. 16A: A schematic depiction of one embodiment of tire vibrations sensor (105) described in FIG. 13, comprising an optical reflective sensor comprising a light source (1051) and a light detector (1052).

FIG. 16B: A schematic depiction of the optical reflective sensor described in FIG. 16A, that is mounted on the inner side (36) of tire (30)

FIGS. 17A and 17B: Schematic depictions of variations of the optical reflective sensor described in FIG. 16A.

FIG. 18: An optical recording of signal from an optical reflective sensor described in FIG. 16A fixed to the inside of a tire that is mounted on a traveling vehicle.

FIG. 19: A graph of the tire patch length as a function of the load on a tire 185/65R1 88 H tire at 36 psi and at vehicle velocity of 42 km/h.

FIG. 20: The response of an optical reflective sensor before (1021), during (1022) and after (1023) crossing the patch area for different tire loads.

FIG. 21: A Fast Fourier Transform (FFT) of the signal recording described in FIG. 18 as was generated by the processor (107) that is described in FIG. 13.

FIG. 22: Tire vibration around frequency of 325 Hz, for different loads applied on the tire.

FIG. 23: A schematic depiction of the optical reflective sensor described in FIG. 6a, and the bending of the tire (1611), (1612) and (1613) for different loads that are applied on the tire while at rest.

FIG. 24: A recording of light intensity measured by the optical reflective sensor (1052) at different loads that are applied on the tire while the tire is static.

FIG. 25: is a schematic depiction of another embodiment of tire vibrations sensor (105) described in FIG. 16A, comprising a magnet (512) and a magnetic sensor (510) fixed to the tire.

FIG. 26: is a schematic depiction of another embodiment of tire vibrations sensor (105) described in FIG. 16A, comprising an electromagnetic sensor (520) fixed to the tire for sensing tire steel reinforcement (310) vibrations during tire vibrations.

### FIELD OF THE INVENTION

This patent application refers to a non-contact sensor for sensing tire vibrations and bends. For example, an optical reflective sensor comprising a light source and a light sensor that are mounted on a tire at about 1 mm from the tire, such that light emitted by the light source is reflected back from the tire to the light sensor from a small spot, such that changes in the received light is a measure a localized tire bending. Another sensing device described in this patent application is a magnet fixed to the tire and a nearby magnetic sensor that senses changes in the magnet flux that are induced by localized movement of the magnet as the tire bends.

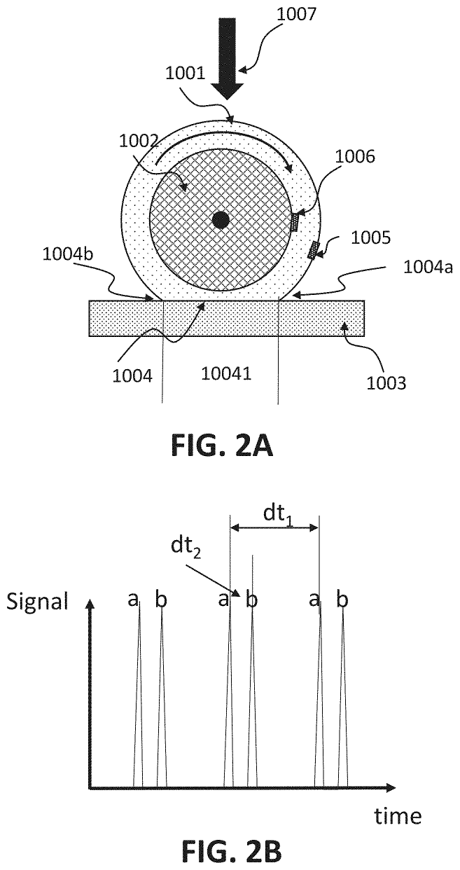

FIG. 2A describes schematically a tire (1001) on a rim (1002) rolling over the ground (1003). The patch is the area (1004) of contact between the tire and the ground. The length of the patch (10041) depends on the tire pressure as measured by a tire pressure sensor (1006) and the load on the tire (1007). The bending of the tire at point (1004a) is the entering point to the patch and the bending of the tire at point (1004b) is the exit point from the patch. In prior art a strain gauge (1005) that is fixed to the tire generates a signal at the entering and exiting points of the patch. This is described schematically in FIG. 2B by signals “a” and “b”. The time difference dt₁ is the time it takes for the wheel to complete a full rotation and dt₂ is the time it takes for the electromechanical device to cross the patch from point 1004a to point 1004b. Therefore, assuming the circumference of the tire is Lₜ the velocity of the vehicle is V=Lₜ/dt₁. In such a case the patch length Lₚ=Vdt₂=Lₜdt₂/dt₁=2pRdt₂/dt₁.

The load on the tire depends on the patch length, on the tire pressure and to some extent on the tire temperature, age, usage time and manufacturer. The load may be calculated either using for example an empirical equation, a lookup table or a machine learning software that considers different properties of the tire and of the environment.

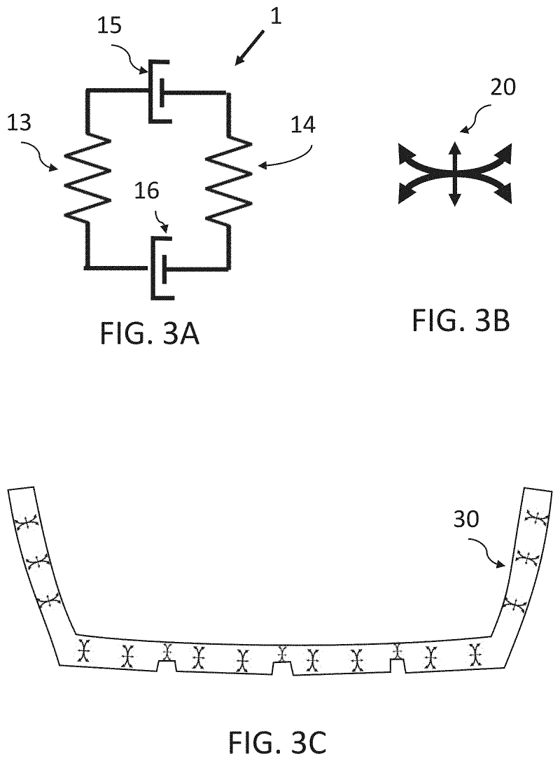

FIG. 3A describes a simplified tire model comprising two tension-compression springs (13), (14), and two dampers (15), (16). This simplified model allows the tire to bend when one spring is tensed, and the other spring is compressed. The model also allows the tire to stretch when the two springs are tensed. Different parts of the tire have different properties and it is clear that the values of the spring constants of the two springs and the damping constant of the two dampers are function of location. FIG. 3B describes the model in FIG. 3A and will be used throughout this patent application to describe the local properties of the tire, FIG. 3C describes a tire (30) using the model described in FIG. 3A and FIG. 3B.

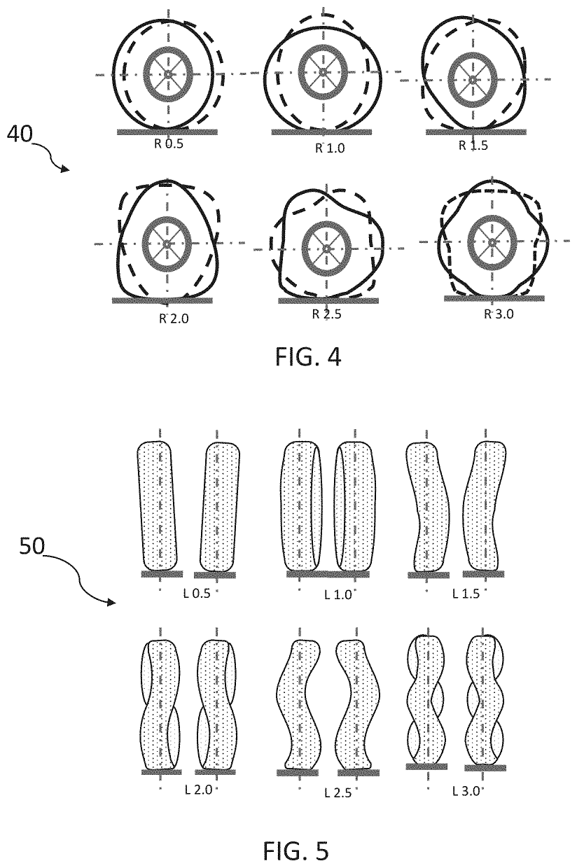

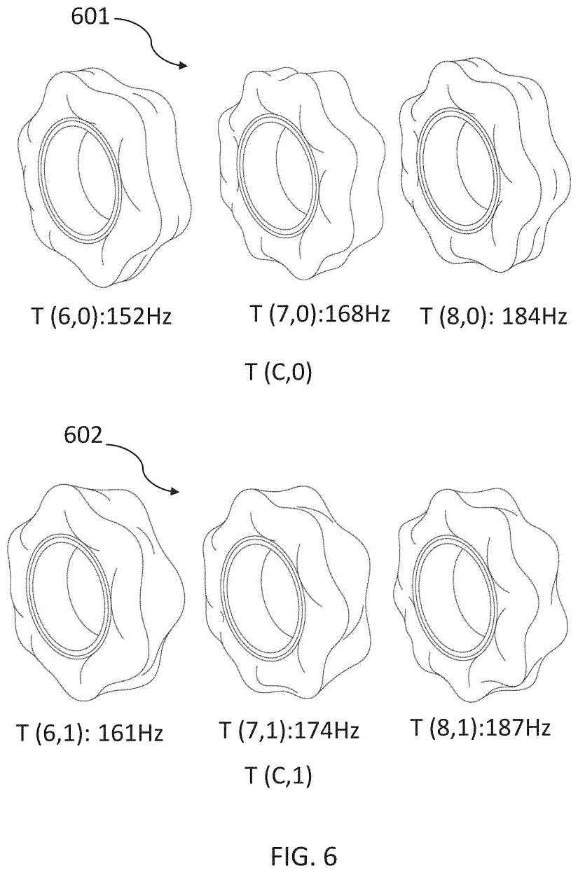

A few of the Radial, Lateral and Transverse modes of a tire are described in FIGS. 4-6. The Radial modes (40) are described in FIG. 4. The first radial mode starts at about 90 Hz and higher modes may go up to 800 Hz with decreasing amplitudes. The Lateral modes (50) are described in FIG. 5. The first lateral mode starts at 30-60 Hz, and higher modes may go up to 120 Hz with decreasing amplitudes. Three symmetrical transverse modes (601) and three non-symmetrical transverse modes (602), along the width of the tire, are described in FIG. 6 for an unloaded tire. The (C, 0) are symmetrical modes while the (C, 1) are asymmetrical modes where “c” is the first index of the mode. The first symmetrical transverse mode starts at about 150 Hz and higher Transverse modes may go up as high as 300 Hz with decreasing amplitudes. The vibration modes described in FIGS. 4-6 are for unloaded tires. Increasing tire load on the tire shifts the mode frequencies to higher frequency as a result of a larger contact patch of the tire with the ground leading to lower vibrating mass and therefore to higher mode frequency. It is noted that the actual mode frequency may vary between different size, material, age and pressure of the tire.

A specific tire vibration mode may be excited either by a continuous vibration of the tire with a similar vibration frequency, or by impacts. Tires modes may be excited by vibration resulting from the vehicle-road interaction, by impacts that are generated by the road or by maneuvering of the vehicle such as acceleration, deceleration and turns. In addition, the boundary conditions that, in part, are determined by the way the tire is in contact with the ground may favor specific modes over others.

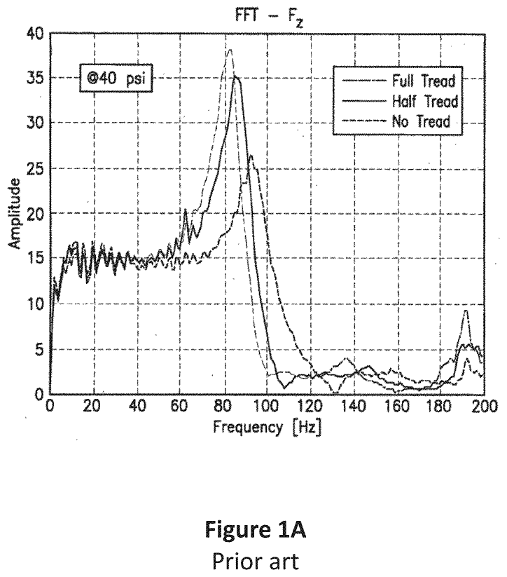

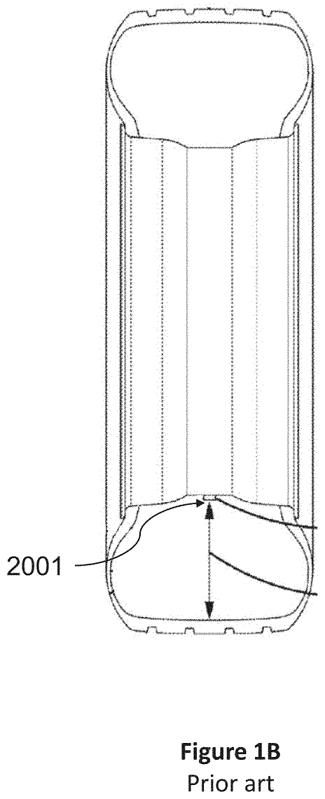

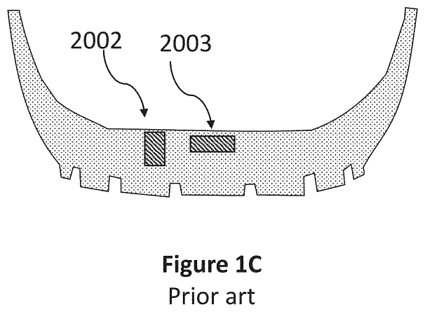

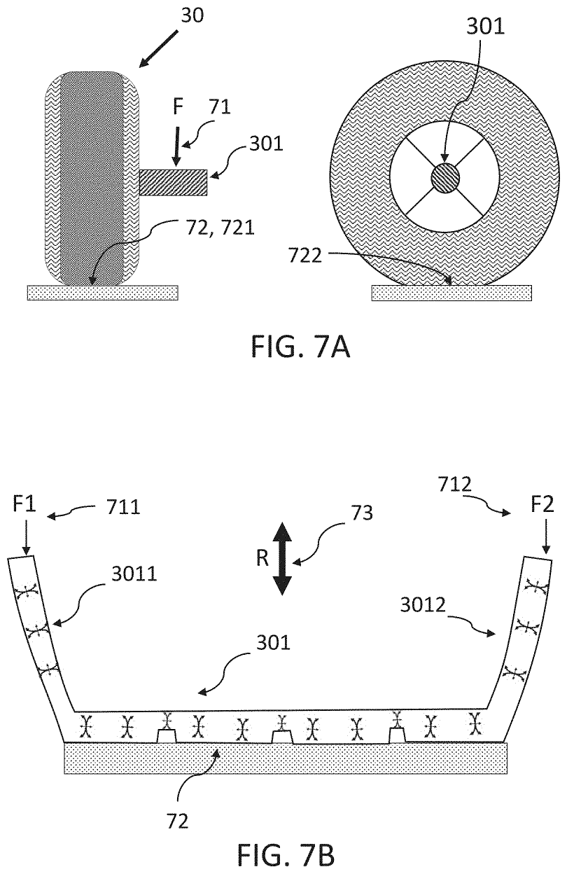

FIGS. 7-12 describes tires in different states. FIG. 7A describes a tire (30) connected to a tire hinge (301), and under a load F, (71). The tire has a uniform contact with the ground forming a contact patch (72) having width (721) and length (722) that wears-out uniformly along the circumference of the tire. FIG. 7B describes schematically the tire (301) and the load F divided into F1 (711) that is applied on the left side of the tire (3011) and F2 (712) that is applied on the right side of the tire (3012). F1+F2=F and for uniform contact with the ground they are practically equal to each other. As the tire that is in contact with the ground wears-out the properties of the tire change and may change the amplitude and frequency of the first radial mode (73) marked by (1, 0), in FIG. 4A. This case is referred to in patent number EP14171347NWB1 as described in FIG. 1B of this patent application.

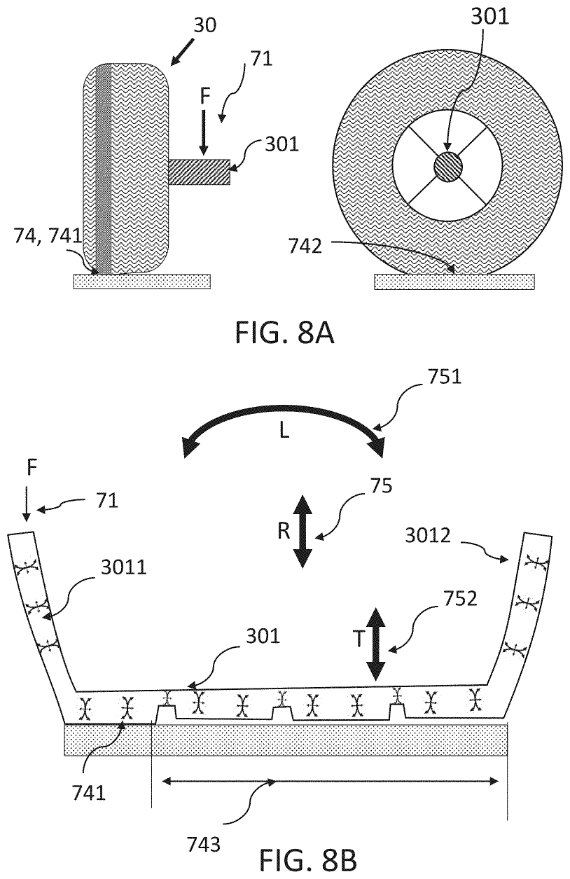

FIG. 8A describes a tire (30) connected to a tire hinge (301) under load (71) such that one side of the tire is in contact with the ground forming a contact patch (74) having width (741) and length (742). FIG. 8B describes schematically the tire (301). Since only the left side is in contact with the ground the load on the tire is applied through the left side of the tire (3011). Since the tire is supported by its left side (3011) the amplitudes of the radial modes may be larger and lateral modes such as the modes described in FIG. 5, may also be excited. In addition transverse modes along the length (743), may also be excited.

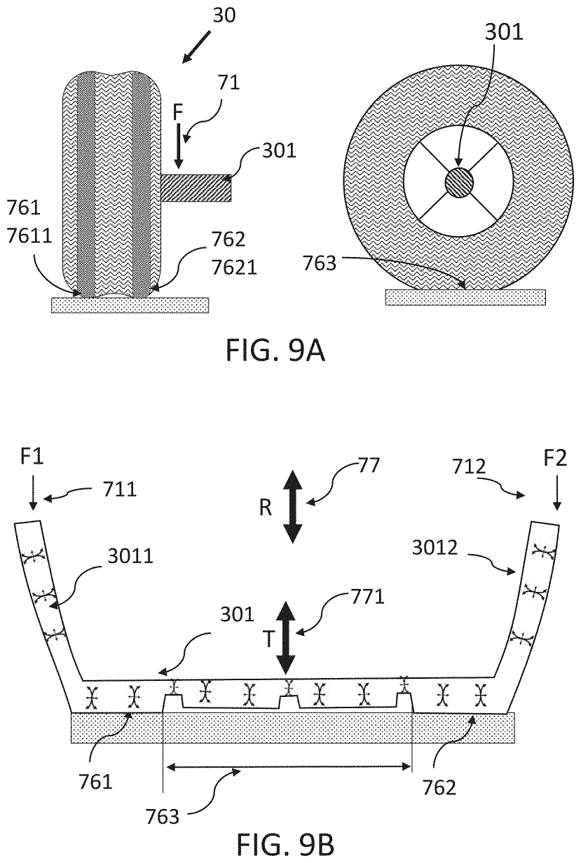

FIG. 9A describes a tire (30) connected to a tire hinge (301) under load (71) and is in contact with the ground in two sides forming two a contact patches (761) and (762) having widths (7611) and (7621) and lengths (763). FIG. 9B describes schematically the tire (301) and the load F divided into F1 (711) that is applied on the left side of the tire (3011) and F2 (712) that is applied on the right side of the tire (3012) F1+F2=F and the ratio between F1 and F2 depends on the ratio between the contact areas (761), (762). As the tire is supported from its two sides the amplitudes of the radial modes may be larger and transverse mode may also be excited. Additional higher vibrational modes may develop between the two patches along the length (763).

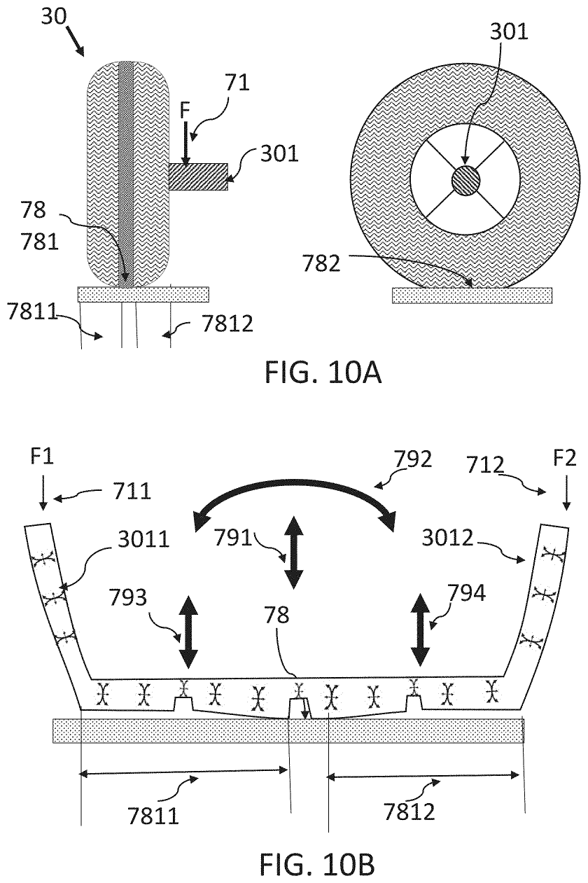

FIG. 10A describes a tire (30) connected to a tire hinge (301) under load (71) that is in contact with the ground forming a contact patch (78) having width (781) and length (782). FIG. 103 describes schematically the tire (301) and the load F divided into F1 (711) that is applied on the left side of the tire (3011) and F2 (712) that is applied on the right side of the tire (3012). F1+F2=F and the ratio between F1 and F2 depends on the ratio between the length extending to the left (7811) of the width (781), and the length extending to the right (7812) of contact width (781). If these two extensions are different from each other, lateral modes (792), such as the modes described in FIG. 5 may be excited.

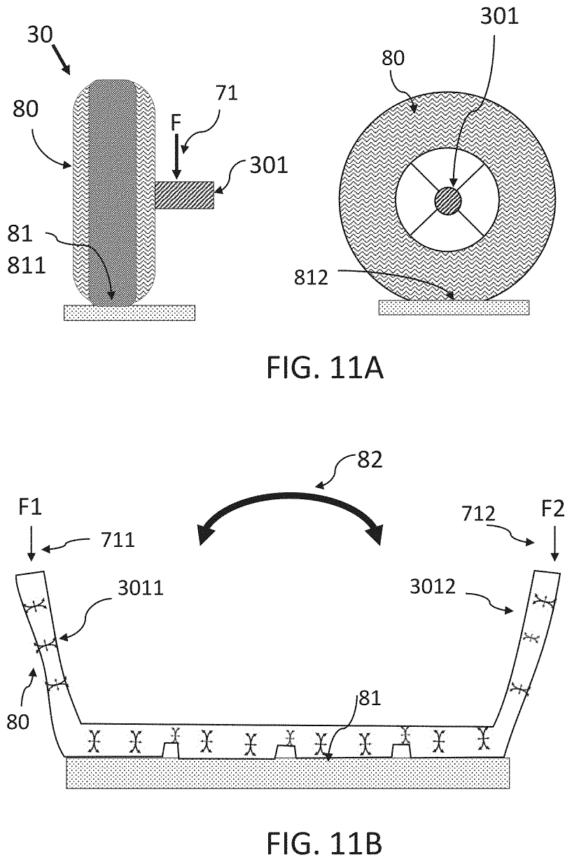

FIG. 11A describes a tire (30) connected to a tire hinge (301) with radial wear-out on the right side of the tire (80), The tire is loaded by load (71) and in contact with the ground (81). In this case it is assumed that the tire makes a uniform contact patch (81) with the ground having width (811) and length (812). Such a wear-out may for example result from tire rubbing with sidewalks. FIG. 11B describes schematically the left side of the tire (3011) and the right side of the tire (3012). F1+F2=F but because of the asymmetry between the tire side (3011) and (3012), F1 may be a bit different than F2. This type of tire wear may change the spring and damping constants of the right side of the tire (3012) relative to the left side of the tire (3011) and may lead to tire lateral vibrational modes (82) for example the lateral modes described in FIG. 5. In addition, such localized wear-out may generate vibration at the rotation rate of the tire.

As the wheel rotates a contact patch, change around the circumference of the tire, For a 0.6 m diameter tire at 200 kmh the rotation rate is about 30 Hz while typically the frequencies of the tire vibrational modes are much higher as described in FIGS. 4-6. At such higher frequencies these modes may develop since at any given time there is a patch that is in contact with the ground while the rest of the tire is free to vibrate. Yet, as the rotation rate increases the contact patch may suppress the development of vibrations that include displacements of the tire along the circumference where the patch or patches are, and support for example higher frequency of transverse modes, away from the contact patch.

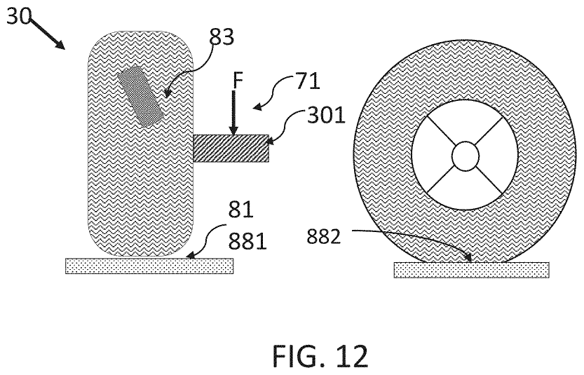

FIG. 12 describes a tire (30) connected to a tire hinge (301) under load (71), with patch wear-out (83) along the circumference of the tire, that may change the vibration and amplitude modes of the tire depending on the location and shapes of the specific patch wear-out. In addition, such localized wear-out may generate vibration that is at the rotation rate of the tire.

It is noted that any combination of tire wear-out described in FIG. 5 is possible, leading to a much more complex change in the tire vibrational modes. In addition, as the tire ages and wear-out, the spring and damping constant of the tire may vary which may also change the vibration modes over the lifetime of the tire.

In the examples described in FIGS. 8-10 and in FIG. 12 the force F, applied on a smaller contact area of the tire with the ground (74), (761), (762), (78) and (83), and therefore the pressure on the tire at these contact areas is higher than in normal conditions, leading to higher rate of wear of the tire. In addition, since the contact area in these cases is smaller, the vehicle maneuvering may be different. For example, the stopping distance is smaller, and the forces applied on the vehicle during braking or during maneuverings are not balanced such that the vehicle behavior may not be predicted.

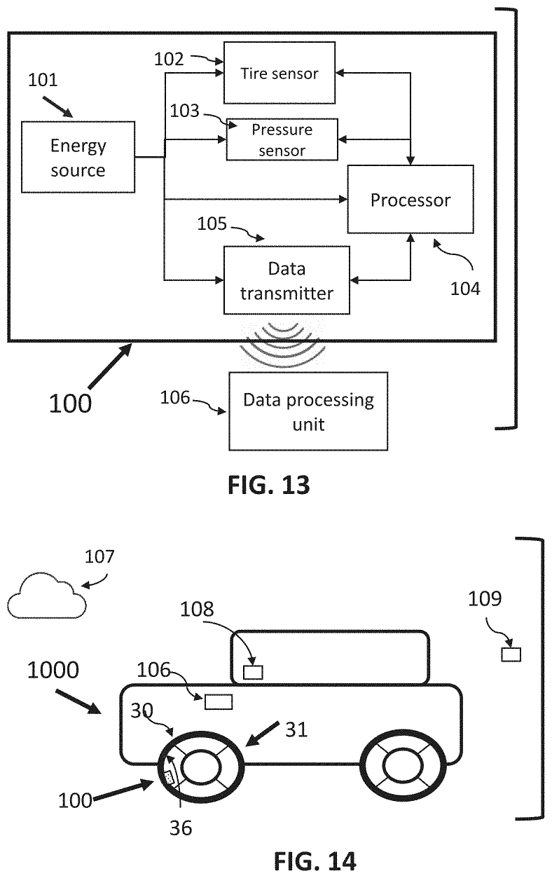

FIG. 13 describes a module (100). The module is fixed to the inside (36) of a tire (30) that is mounted on wheel (31) of a vehicle (1000) as described in FIG. 14. The module comprises an energy source (101), a pressure sensor (103) and at least one tire sensor (102) for measuring tire properties. The module also comprises a transmission module (105) and a processor (104) for processing the module activity such as timing the sampling of the sensors receiving the data from the sensors and transmitting the data to a data processing unit (106) outside the vehicle. For most practical use, the processing of the information for example using Machine Learning may take place by the data processing unit. Such Machine Learning may learn not only from the data collected from the specific vehicle (1000) but also from tires of other vehicles, through data received from a cloud (107). Yet it is understood that data processing or partial data processing may take place also by the processor and if all processing takes place by the processor, the data processing unit is only a bridge to the vehicle computer.

The module (100) described in FIG. 13 may also be used to calculate the load on a tire using the signal generated by the tire vibration sensor as it crosses the patch area. The module may take into account the tire age, tire wear and tire maker and tire size such as tire radius, tire width and aspect ratio as these properties may also affect the patch properties.

The module (100) described in FIG. 13 may also be used to calculate the road roughness which typically is in the range of 10 Hz-20 Hz. The module may also predict when the vehicle is driving on off road where vehicle vibrations in the range of 1 Hz-3Hz may be sensed through the same frequency of tire radial bends of the tire. Road roughness measurement may require knowing the tire pressure and rotation rate.

The data processing unit (106) described in FIG. 13 may include a machine learning (ML) software that in addition to the tire vibration frequencies and amplitudes, and the tire contact patch characteristics, the ML may also consider the tire pressure, the tire dimensions, the tire temperature, tire temperature history, tire load history, tire age, road roughness, road roughness history of the tire, and the tire material and maker.

For some analyses the data processing unit (106) may compare the vibrations frequency and amplitudes or the tire contact patch characteristics of the tire with the ground to the tires properties saved in a database. This database may include the history of the specific tire and the history of the tire as measured by other vehicles and saved in a cloud.

The data processing unit (106) may send alerts related to the state of the tire and state of tire traction with the road, to the driver through a monitor (108) on the driver dashboard, and to a fleet management (109). The data processing unit (106) may also send information to the vehicle autonomous supporting system such as the vehicle Advanced driver-assistance systems (ADAS) taking into account the properties of the tire contact with the road, and the road condition in order to adjust the vehicle autonomous parameters such as stopping time, braking parameters of each wheel, vehicle behavior during braking or during cornering.

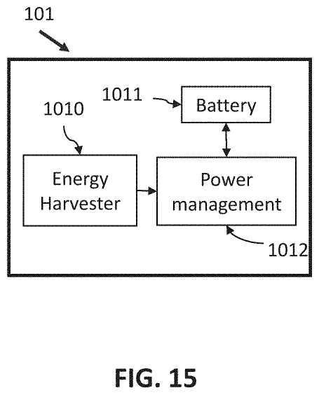

The Energy source (101) may be a battery, or an energy harvester (1010) as described in FIG. 15, that for example may harvest kinetic energy from the wheel rotation. Such a harvester may be Electromagnetic, piezoelectric, or electrostatic harvester or any combination of these kinetic harvesters. The energy harvester may harvest energy from heat or from a RF source. In FIG. 15 an energy harvester is shown supported by a power management circuit (1012) that manages the power generated by the harvester, and a battery (1012). The battery may be a non-rechargeable battery that powers the module when the Energy Harvester doesn't harvest enough power to power the module. The battery may be a rechargeable battery that is charged by the power management using common methods such that the rechargeable battery may support the module when required. The power management manages the power generated by the harvester and the power in the battery and depending on a preferred power schematics, powers the sensors, the transmitter, and the processor.

Tire vibration sensor (105) may be for example an accelerometer or a strain gauge. It is noted that higher modes typically have low amplitude. Therefore in-order to detect them, the sensor should have low Signal to Noise ratio (SNR). Accelerometer has a relatively large SNR due to Brownian noise. Strain gauge is a sensor that is attached to the tire and senses its bends and vibrations and typically has a better SNR than an accelerometer. Both, the accelerometer, and strain gauge, go through bending in order to sense vibration and therefore their lifetime is determined by the level of vibration and number of bending cycles.

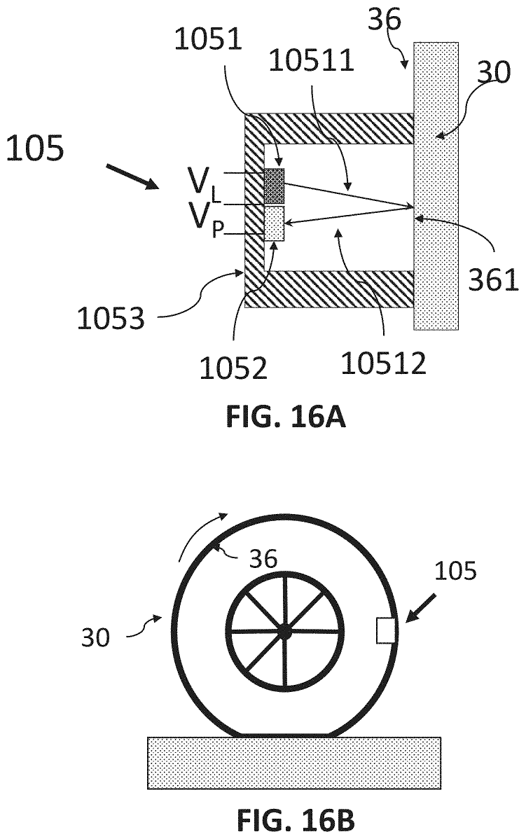

FIG. 16A describes a reflective optical sensor (105) for sensing tire vibrations and bends comprising a light source (1051) and the light sensor (1052). The sensor is mounted on a chassis (1053) that is fixed to the inside of a tire (36), as shown in FIG. 16B, such that part of the light is emitted (10511) from the light source and reflected (10512) from the tire (361) back to the light sensor. As the wheel rotates vibrations of the tire are sensed from changes in the intensity of the light received by the optical sensor. A reflector (1614) may be formed on the tire that reflects the light back to the optical sensor. In FIG. 16A one reflective optical sensor is shown, but it is understood that several such sensors may be used in different locations in order to sense different vibration modes or bends of the tire,

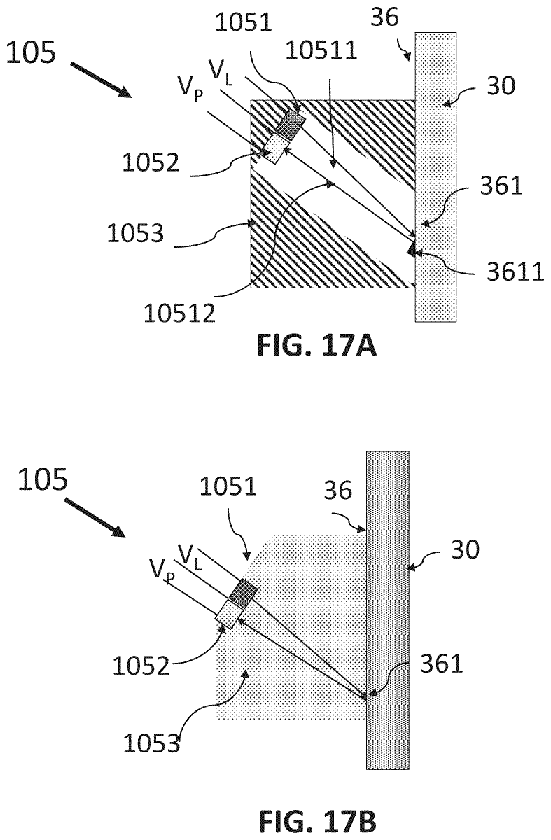

FIG. 17A is another embodiment of the tire vibration sensor (105) described in FIG. 16A such that the light source (1051) and light sensor (1052) are tiled such that light is reflected from the tire outside the area of the chassis (1053). The Chassis may be a flexible material and may seal the path of the light completely in order to prevent contamination. A reflector (3611) may be fixed to the tire in order to enhance the intensity of light (10512) that is reflected back to the light sensor.

FIG. 17B is another embodiment of the tire vibration sensor (105) described in FIG. 16A such that the light source (1051) and light sensor (1052) are tiled and are fixed to a flexible chassis that is transparent to the light emitted by the light source and such that the light source and light sensor are completely sealed in order to prevents contamination from coating the light source or light sensor and the reflected area.

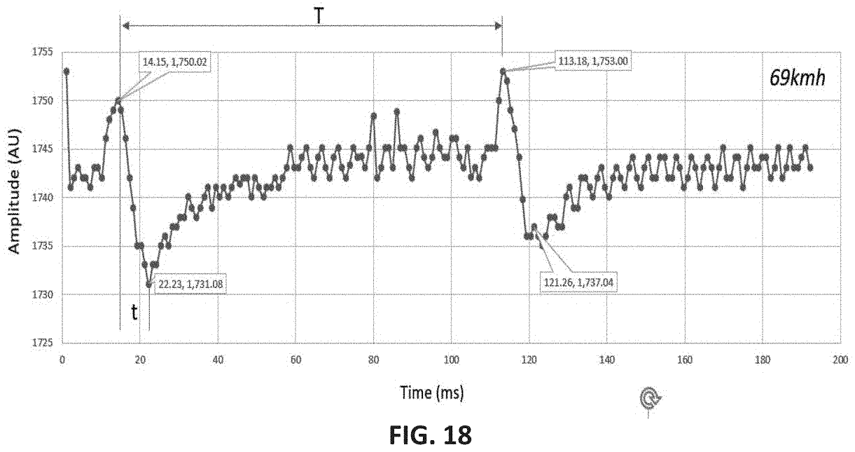

FIG. 18 describes a recording of the light intensity that is sensed by the reflective optical sensor that is described in FIG. 16A. The time “T” is the time of one revolution and “t” is the time it takes the spot to cross the patch.

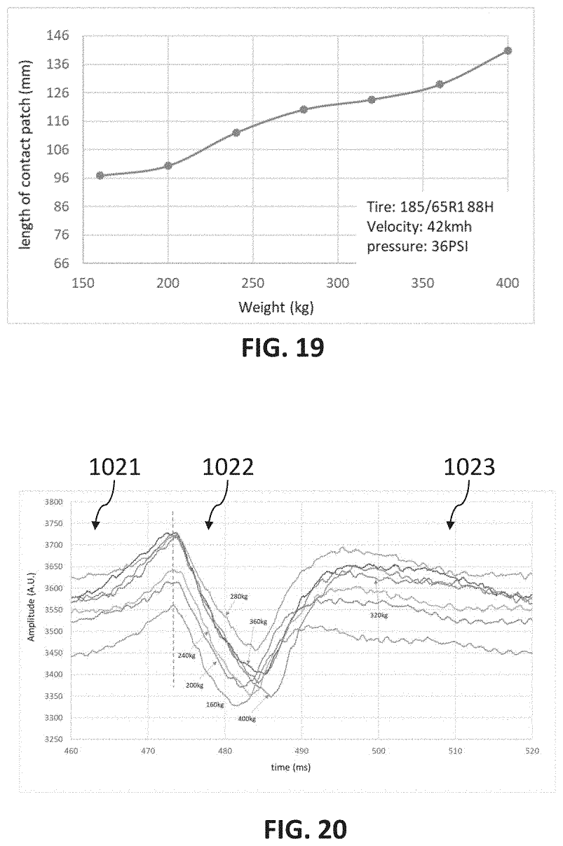

FIG. 19 shows a mostly linear chart of the patch length, calculated from measurements of the time “t”, for different loads on the tire (160 kg, 200 kg, 240 kg, 280 kg, 320 kg, 360 kg, 400 kg). These measurements took place on a 185/65R1 88 H tire at 42 km/h and tire pressure of 36 psi. FIG. 20 shows the response of the sensor before (1021), during (1022), and after (1023) it crosses the patch area for the different loads. Despite the linear relation between the patch length and the load on the tire as described in FIG. 19, it is noted that the shapes of the responses are different from each other. For example, going to the right from the vertical dash line we find the response of the following loads: 160 kg, 200 kg, 240 kg, 400 kg, 320 kg, 360 kg, 280 kg. More specifically, it is shown that the baseline of each signal is different and is correlated to a specific weight. This means that the response of the optical signal to different loads on the tire carries information about the weight not only across the patch but also outside the patch area. This information, in addition to the patch length, may be used by a Machine Learning (ML) software to extract a higher accuracy of tire load measurements. Such a ML software may also consider the tire dimensions, age, manufacturing date and maker, history of the specific tire and data from other similar or different tires.

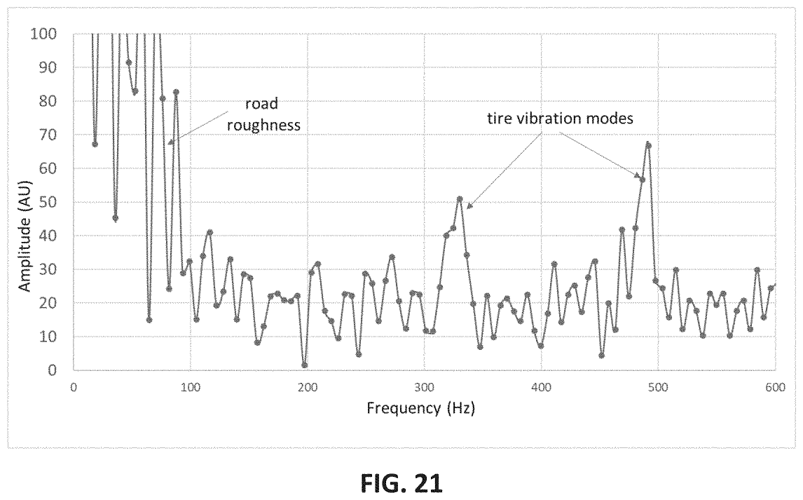

FIG. 21 is the Fast Fourier Transform (FFT) of this recording in FIG. 18 showing the different vibrational modes of the tire. The time T repeats itself as the wheel rotates and therefore the rotation rate and vehicle speed may be also calculated from the FFT.

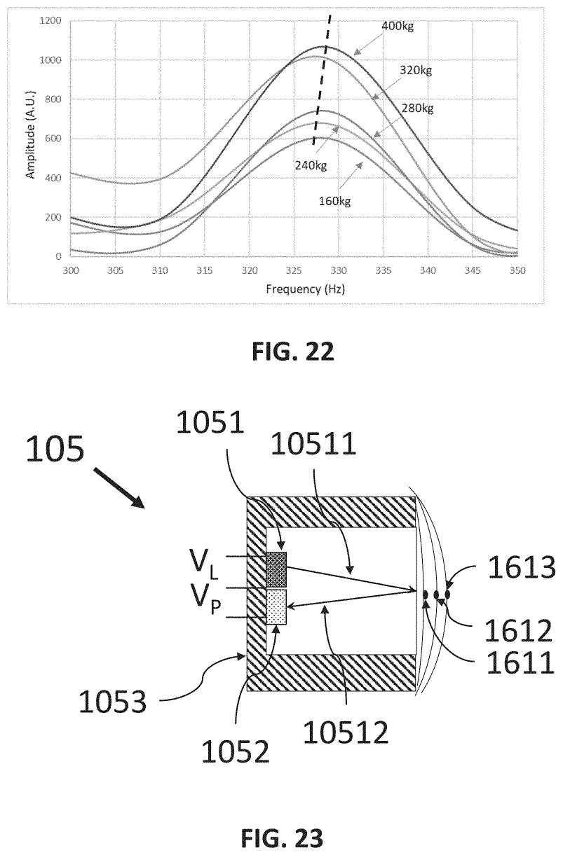

FIG. 22 describes the FFT of tire vibration at different loads applied on the tire. The FFT focuses on the frequency response around 325 Hz. It is noted that the amplitude of the FFT signal increases with the load. In addition a slight shift of the peak towards higher frequency, as indicated by the dashed line, is also noticed.

FIG. 23 describes a close view of the tire where the system is located with different loads that are applied on the tire. As the load increases the patch area increases as well, which expends the tire elsewhere radially. Therefore, different loads will result with different bending of the tire and therefore different intensity of light that is sensed by the optical sensor. In FIG. 23 points (1611), (1612), and (1613) describes schematically three radial expansions of the tire such that point (1611) represent the expansion of the tire with lower load than that of point (1612) and point (1612) represent the expansion of the tire with lower load that that of point (1613). The light intensity reflected back to the optical sensor from point (1611) is higher than that of point (1612) and the light intensity reflected back from point (1612) is higher than that of point (1613). This allows calculation of the load even when the tire is not rolling.

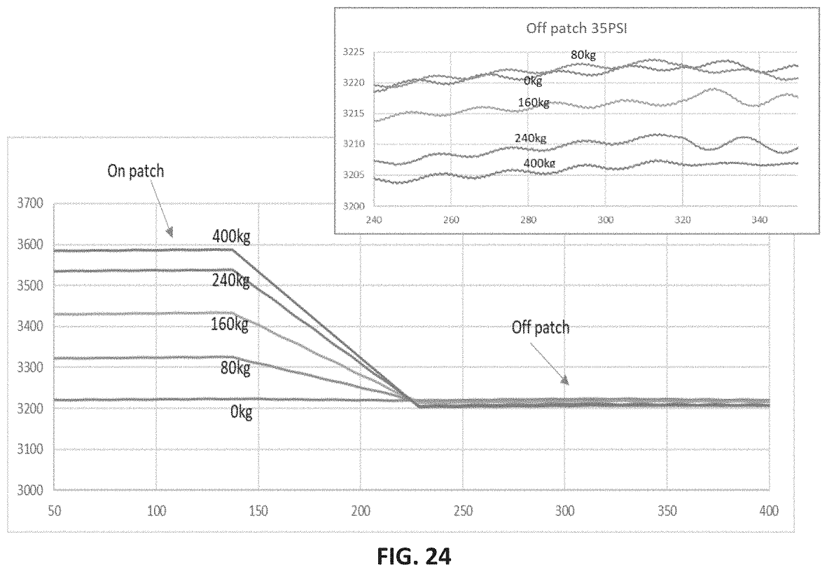

FIG. 24 are measurements of the light intensity that is sensed by the reflective optical sensor when different weights are applied on a static tire when the reflective optical sensor is facing the patch and when it is off the patch. These results show that different weights produce different optical signals since the bending of the tire is different under different loads, In addition, it shows that when the sensor faces the patch the intensity is higher for large loads and smaller as the load decreases. On the other hand, off the patch area the order is reversed.

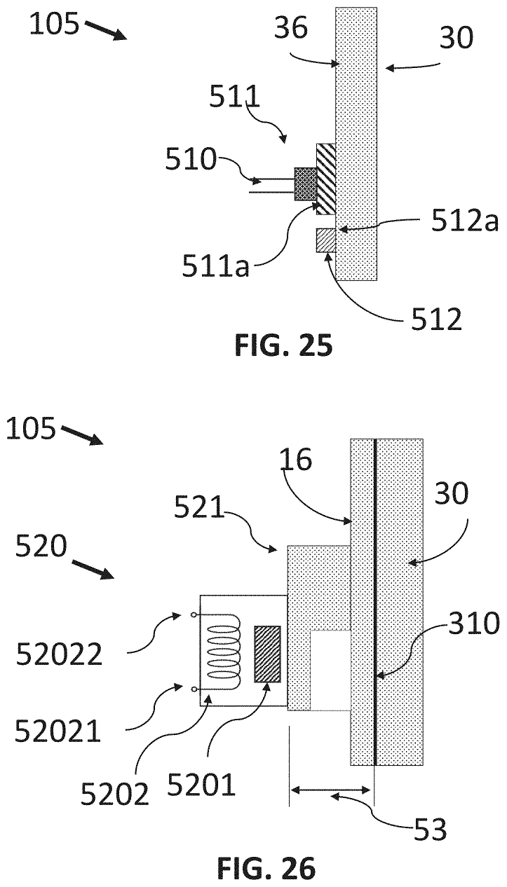

FIG. 25 describes another embodiment of tire vibration sensor (105). In this embodiment the sensor (105) comprises a magnetic sensor (510) mounted on a chassis (511) at location (511a) and a magnet (512) mounted on the tire at location (512a) such that location (511a) is close to location (512a). The tire vibrations are translated into vibrations of magnet (512) relative magnetic sensor (510) and are recorded by magnetic sensor. Magnet (512) may be a simple magnet in any preferred orientation or some combination of magnets such that the vibrations of the tire results in a high change of the signal in the magnetic sensor.

FIG. 26 describes another embodiment of tire vibration sensor (105). In this embodiment sensor (105) comprises an electromagnetic sensor (520) mounted on chassis (512) such that the electromagnetic sensor is sensitive to changes in distance (53) to the steel mesh (310) embedded inside the tire and such that tire vibration are sensed by the electromagnetic sensor. The electromagnetic sensor (520) may comprise, for example, a magnet (5201) and a coil (5202) such that movement of the steel mash changes the magnetic flux around the magnet that induces voltage drop between the two ends of the coil.

The vibration sensors described in FIG. 25 and FIG. 26 are shown fixed to the chassis (511) and (512) that are part of module (100). These sensors may be also fixed to the tire directly.

From the above explanations it is understood that the present invention discloses a system for a tire that is designed to be mounted on a wheel of a vehicle traveling on a road. The system comprises a chassis, a light source, a light sensor, a data transmission unit, a processing unit, and a power source for powering the system. The chassis is designed to be attached to the inner side of the tire, and the light source and the light sensor are attached to the chassis in such a way that when the light source illuminates at a specific area on the inner side of the tire, a returning light can be detected by the light sensor. The light sensor is designed to produce a signal based on changes in intensity of the detected light, and these changes can reflect frequencies and amplitudes of vibrations of the tire or bends of the tire when the specific area crosses a contact patch of the tire with the road, or both. Based on the signal, the processing unit is designed to detect characteristics of the contact area of the tire with the road, to detect a type of the road the vehicle is traveling on, to detect a degree of wear of the tire, or to detect a size of load on the wheel.

The system can include a magnetic sensor and a magnet (instead of the light source and the light sensor), and in such case the magnetic sensor and the magnet are attached to the inner side of the tire in such a way that the magnetic sensor can detect a magnetic field of the magnet. The magnetic sensor is designed to produce a signal based on changes in intensity of the detected magnetic field of the magnet, and these changes can reflect frequencies and amplitudes of vibrations of the tire or bends of the tire when the magnet crosses a contact patch of the tire with the road, or both. Here too, based on the signal, the processing unit is designed to detect characteristics of the contact area of the tire with he road, to detect a type of the road the vehicle is traveling on, to detect a degree of wear of the tire, or to detect a size of load on the wheel.

The system can include an electromagnetic sensor (instead of the light source and the light sensor or instead of the magnet and the magnetic sensor), and in such case the electromagnetic sensor is designed to be attached to the inner side of the tire that is reinforced by a steel mesh in such a way that the electromagnetic sensor can detect a magnetic field of the steel mesh. The electromagnetic sensor is designed to produce a signal based on changes in intensity of the detected magnetic field of the steel mesh, and these changes can reflect frequencies and amplitudes of vibrations of the tire or bends of the tire when the electromagnetic sensor crosses a contact patch of the tire with the road, or both. Here too, based on the signal, the processing unit is designed to detect characteristics of the contact area of the tire with the road, to detect a type of the road the vehicle is traveling on, to detect a degree of wear of the tire, or to detect a size of load on the wheel.

The present invention also refers to a method for detecting characteristics of a contact area of a tire that is mounted on a wheel of a traveling vehicle with a road, detecting a type of the road, detecting a degree of wear of the tire, detecting an alignment degree of the tire, or detecting a size of load on the wheel. The method includes the following steps: (a) producing a signal that reflect frequencies and amplitudes of vibrations of the tire while the vehicle is traveling or reflect bends of the tire at a contact patch of the tire with the road, or both, and (b) providing a processing unit that is designed to detect the characteristics of the contact area of the tire with the road, to detect the type of the road the vehicle is traveling on, to detect the degree of wear of the tire, to detect the alignment degree of the tire, or to detect the size of load on the wheel.

The processing unit can be designed to transmit information as to the detected characteristics of the contact area of the tire with the road, the detected type of the road, the detected degree of wear of the tire, the detected alignment degree of the tire, or the detected a size of load on the wheel to a mean of indication in the vehicle that can be visible to the driver of the vehicle, to the fleet management center, or to the autonomous driving system of the vehicle so that the information can be used for adjusting vehicle driving parameters. The power source can be a battery or an energy harvester that converts kinetic energy to electricity. The power source can include an energy harvester that is designed to convert the kinetic energy to electricity, a rechargeable battery and power management circuit for managing the harvested power and for charging the rechargeable battery.

What is claimed is:

1. A system for a tire that is designed to be mounted on a wheel of a vehicle traveling on a road that comprises a chassis, a light source, a light sensor, a data transmission unit; a processing unit, and a power source for powering the system; wherein the chassis is designed to be attached to an inner side of the tire; wherein the light source and the light sensor are attached to the chassis in such a way that when the light source illuminates at a specific area on the inner side of the tire, a returning light can be detected by the light sensor; wherein the light sensor is designed to produce a signal based on changes in intensity of the detected light; wherein said changes can reflect frequencies and amplitudes of vibrations of the tire or bends of the tire when the specific area crosses a contact patch of the tire with the road; and wherein based on the signal, the processing unit is designed to detect characteristics of the contact area of the tire with the road, to detect a type of the road the vehicle is traveling on, to detect a degree of wear of the tire, or to detect a size of load on the wheel.

2. The system according to claim 1, wherein said processing unit is further designed to transmit information as to said detected characteristics of the contact area of the tire with the road to a mean of indication in said vehicle that can be visible to a driver of the vehicle, to a fleet management center, or to an autonomous driving system of the vehicle so that the information can be used for adjusting vehicle driving parameters.

3. The system according to claim 1 wherein said power source is a battery or an energy harvester that converts kinetic energy to electricity.

4. The system according to claim 1 wherein said power source comprises an energy harvester that is designed to convert kinetic energy to electricity, a rechargeable battery and power management circuit for managing the harvested power and for charging the rechargeable battery.

5. A system for a tire that is designed to be mounted on a wheel of a vehicle traveling on a road that comprises a magnetic sensor, a magnet, a data transmission unit, a processing unit, and a power source for powering the system; wherein the magnetic sensor and the magnet are attached to an inner side of the tire in such a way that the magnetic sensor can detect a magnetic field of the magnet; wherein the magnetic sensor is designed to produce a signal based on changes in intensity of the detected magnetic field of the magnet; wherein said changes can reflect frequencies and amplitudes of vibrations of the tire or bends of the tire when the magnet crosses a contact patch of the tire with the road; and wherein based on the signal, the processing unit is designed to detect characteristics of the contact area of the tire with the road, to detect a type of the road the vehicle is traveling on, to detect a degree of wear of the tire, or to detect a size of load on the wheel.

6. The system according to claim 5, wherein said processing unit is further designed to transmit information as to said detected characteristics of the contact area of the tire with the road to a mean of indication in said vehicle that can be visible to a driver of the vehicle, to a fleet management center, or to an autonomous driving system of the vehicle so that the information can be used for adjusting vehicle driving parameters.

7. The system according to claim 5 wherein said power source is a battery or an energy harvester that converts kinetic energy to electricity.

8. The system according to claim 5 wherein said power source comprises an energy harvester that is designed to convert kinetic energy to electricity, a rechargeable battery and power management circuit for managing the harvested power and for charging the rechargeable battery.

9. A system for a tire that is designed to be mounted on a wheel of a vehicle traveling on a road that comprises an electromagnetic sensor, a data transmission unit, a processing unit, and a power source for powering the system; wherein the electromagnetic sensor is designed to be attached to an inner side of the tire that is reinforced by a steel mesh in such a way that the electromagnetic sensor can detect a magnetic field of the steel mesh; wherein the electromagnetic sensor is designed to produce a signal based on changes in intensity of the detected magnetic field of the steel mesh; wherein said changes can reflect frequencies and amplitudes of vibrations of the tire or bends of the tire when the electromagnetic sensor crosses a contact patch of the tire with the road; and wherein based on the signal, the processing unit is designed to detect characteristics of the contact area of the tire with the road, to detect a type of the road the vehicle is traveling on, to detect a degree of wear of the tire, or to detect a size of load on the wheel.

10. The system according to claim 9, wherein said processing unit is further designed to transmit information as to said detected characteristics of the contact area of the tire with the road to a mean of indication in said vehicle that can be visible to a driver of the vehicle, to a fleet management center, or to an autonomous driving system of the vehicle so that the information can be used for adjusting vehicle driving parameters.

11. The system according to claim 7 wherein said power source is a battery or an energy harvester that converts kinetic energy to electricity.

12. The system according to claim 7 wherein said power source comprises an energy harvester that is designed to convert kinetic energy to electricity, a rechargeable battery and power management circuit for managing the harvested power and for charging the rechargeable battery.

13. The system according to claim 9 wherein said electromagnetic sensor comprises a magnet and a coil, such that vibrations of said steel mash changes the magnetic field in the coil that induces voltage between two ends of the coil.

14. A method for detecting characteristics of a contact area of a tire that is mounted on a wheel of a traveling vehicle with a road, detecting a type of the road, detecting a degree of wear of the tire, detecting an alignment degree of the tire, or detecting a size of load on the wheel, comprising:
producing a signal that reflect frequencies and amplitudes of vibrations of the tire while the vehicle is traveling or reflect bends of the tire at a contact patch of the tire with the road; and
providing a processing unit that is designed to detect the characteristics of the contact area of the tire with the road, to detect the type of the road the vehicle is traveling on, to detect the degree of wear of the tire, to detect the alignment degree of the tire, or to detect the size of load on the wheel.
